(19) United States
(12) Patent Application Publication
(10) Pub. No.: US 2003/0047887 A1
(43) Pub. Date: Mar. 13, 2003

(54) Tool holder for hammer

(76) Inventor: Norbert Hahn, Limbach (DE)

Correspondence Address: THE BLACK & DECKER CORPORATION, 701 EAST JOPPA ROAD, TOWSON, MD, 21286, US

(21) Appl. No.: 10/241,087

(22) Filed: Sep. 11, 2002

(30) Foreign Application Priority Data
Sep. 12, 2001 (GB) 0121958.3

(51) Int. Cl. B23B 5/22

(52) U.S. Cl. 279/19.1

(57) ABSTRACT

A tool holder, in a powered hammer, for non-rotatably receiving a tool shank having an axially extending closed groove, said tool holder comprising: a tool holder body defining an axial bore and a radial slot; a locking body located in said slot and moveable between a radially inward position and a radially outward position; a locking member movable between a locked position and a release position and when in the locked position said locking member locks the locking body in the radially inward position and when in the release position said locking member allows the locking body to move into the radially outward position; a tool holder release sleeve operatively connected to the locking member for moving the locking member; a warning surface, which warning surface is covered when the locking body engages the groove in the tool shank and; wherein the tool holder is arranged so that when a tool shank is fitted into the tool holder body in an incorrect orientation, then the tool shank traps the locking body in the radially outward position and the warning surface is visible to a user of the tool holder.

### BACKGROUND OF INVENTION

This invention relates to a tool holder for hand held electrically powered hammers and to a hand held electrically powered hammer incorporating such a tool holder. In particular this invention relates to tool holders for demolition hammers.

Such hammers generally comprise a housing within which is located an electric motor and an arrangement for converting the rotary drive of the motor to a reciprocating drive to drive a piston within a hollow spindle or cylinder, which spindle is located within the hammer housing. A ram is located in front of the piston within the spindle so as, in normal operating conditions, to form a closed air cushion within the spindle between the piston and the ram. The reciprocation of the piston reciprocatingly drives the ram via the air cushion. A solid or a hollow piston arrangement can be used as is well known in the art. A beatpiece is generally located within the spindle and transmits repeated impacts that it receives from the ram to a tool or bit releaseably mounted for limited reciprocation in front of the beatpiece in a tool holder portion. The impacts on the tool or bit are transmitted to a workpiece against which the tool or bit is pressed in order to break up or make a bore in the workpiece.

Some hammers may also be employed in combination impact and drilling mode in which the tool holder, and hence the tool inserted therein, will be caused to rotate at the same time as the tool is struck by the beatpiece. The present invention is also applicable to such hammers.

A common form of chiselling tool or bit, for performing heavy duty work is a so called hex-shanked tool or bit. An example of the shank end, ie. the end inserted into the tool holder portion of a hammer is shown in FIGS. 3a to 3d. The portion of the tool which is locked within the tool holder of the hammer has a hexagonal transverse cross-section. The bore in the tool holder which receives the hexagonal shank portion has a corresponding hexagonal transverse cross-section. Accordingly, the tool can be fitted within the tool holder in one of six orientations. The hexagonal portion is formed on one of its flats with an axially extending groove which is closed at both its ends. The hex-shanked tool can be locked within the tool holder by a locking body of the tool holder engaging in the groove to enable limited reciprocation of the tool within the tool holder. In traditional hammers a cross bolt arrangement is used to lock the tool within the tool holder. The bolt has a portion which extends tangentially of the toolholder to engage the groove in the tool. The bolt can be retracted along its longitudinal axis or pivoted outwardly to allow insertion or removal of the tool.

It is advantageous to provide a type of tool holder comprising a radially shiftable locking body which can be releaseably locked within the groove of a tool inserted into the tool holder. Such tool holders are more ergonomic and easier to use and are preferred by the hammer user. In addition they can be designed to provide forward damping for the impact transferred from the tool to the tool holder on entry into idle mode.

Some such tool holders for smaller hammers enable automatic locking of an SDS-type tool within the tool holder. When the tool is inserted into the tool holder, the or each locking body is pushed radially outwardly by the rearward end of the tool against a spring force from a biasing arrangement and then the tool can be moved further into the tool holder until the axially extending groove is located radially inwardly of the locking body. Then the or each locking body is urged radially inwardly to engage the groove, by the spring force from the biasing arrangement.

However, if a hex-shanked tool, as described above were to be used in combination with such an automatic locking tool holder, the tool may inadvertently be inserted into the tool holder with the axially extending groove not facing the locking body and instead with a non-grooved flat of the tool facing the locking body. If this were to occur, then the locking body is pushed radially outwardly by the rearward end of the tool against the spring force from the biasing arrangement and then the tool can be moved fully into the tool holder. However, the locking body remains in its radially outward position and the tool is not locked within the tool holder.

In tool holders that do not allow automatic locking but which have one or more radially moveable locking bodies the same problem can occur for hex-shanked tools. In such tool holders a tool release sleeve is manually actuated to allow a tool to be inserted into a tool holder. The sleeve is then released and the release of the sleeve urges the locking body into the receiving groove of the tool to thereby lock the tool in the tool holder. If a user inadvertently inserts a hex-shanked tool in an incorrect orientation so that the locking body cannot engage the groove in the shank of the tool, then the sleeve, when released will not move into its locked position and the locking body will not be locked in the receiving groove.

This problem has been solved in the past and in particular for smaller hammers and SDS-type bits by making the tool shank insertable into the tool holder in one orientation only by providing irregularly positioned radially inwardly extending splines in the bore of the tool holder and co-operating axially extending grooves, open at their rearward end in the tool shank. However, for larger hammers, the standard tool shank is the hex-shanked tool described above.

### SUMMARY OF INVENTION

The present invention aims to overcome at least some of the problems discussed above by providing an ergonomic and robust design of tool holder with a radially moveable locking body suitable for use with a hex-shanked tool or bit and which prevents inadvertent insertion of the tool into the tool holder in the incorrect orientation.

According to a first aspect of the present invention there is provided a tool holder for a hand held electrically powered hammer, comprising:

a tube-like tool holder body which can be fitted to or formed at the front of the hammer and having a forward end for non-rotatably receiving a hexagonally cross-sectioned shank of a hex-shanked tool or bit wherein said forward end is formed with a single axially extending slot;

a single locking body extending through said slot for releasably engaging an axially extending closed groove formed in the hex-shanked tool fitted in said forward end of the tool holder body;

a locking member which in a locked position locks the locking body in a radially inward position in which the locking body is engageable with the groove in the tool and which in a release position allows the locking body to move into a radially outward position to allow a tool to be inserted into or removed from the forward end of the tool holder body;

a manually actuable tool release sleeve which is moveable to move the locking member between its locked and release positions to allow insertion and/or removal of a tool from the forward end of the tool holder body;

wherein the tool holder further comprises a brightly coloured warning surface, which warning surface is covered by a part of the tool holder when the locking body engages the groove in the hex-shanked tool and the tool holder is arranged so that when a hex-shanked tool is fitted into the forward end of the tool holder body in an incorrect orientation, the locking body is trapped by the shank of the tool in its radially outward position and whilst the locking body is trapped the warning surface is exposed and made clearly visible to a user of the tool holder.

In the arrangement according to the present invention when a hex-shanked bit is inadvertently inserted into the forward end of the tool holder in the incorrect orientation, so that the locking body cannot engage in the groove in the tool to lock the tool in the tool holder the user of the tool is warned by the exposure of a brightly coloured warning surface. The user can then remove the tool and re-insert it in the correct orientation in which the locking body engages the groove to securely lock the tool within the tool holder. When the tool is correctly inserted and locked within the tool holder the warning surface is hidden.

The part of the tool holder covering the warning surface when the locking body engages the groove in the shank of the tool is preferably the tool release sleeve. In a preferred embodiment the trapping of the locking body in its radially outward position traps the tool release sleeve in a position in which it does not cover the warning surface so that the warning surface is exposed and made clearly visible to a user of the tool.

In one embodiment of the tool holder according to the present invention, the tool release sleeve must be manually actuated between a locked and release position to allow insertion of a tool into the tool holder. In this embodiment the brightly coloured warning surface is located underneath the tool holder release sleeve in the locked position of the sleeve and is exposed by movement of the tool release sleeve into its release position, then the locking body blocks movement of the sleeve back into its locked position if the tool is inserted in an incorrect orientation. This means that the warning surface remains exposed if the tool is inserted in the incorrect orientation. The exposure of the warning ring and the fact that the sleeve does not move into its release position when released alert the user to the fact that the tool is not locked within the tool holder. The user can then re-insert the tool in the correct orientation in which the locking body can move radially inwardly into the groove in the tool to allow the sleeve to move to its locked position and cover the warning surface.

In a version of this latter embodiment the rearward end of the slot in the forward end of the tool holder body prevents the locking body from moving to a radially outward position rearward of the locking member and the tool release sleeve is manually slideable axially rearwardly to enable the locking body to move into a radially outward position forward of the locking member to allow insertion of a tool, wherein the brightly coloured warning surface is located underneath the forward end of the tool holder release sleeve in its locked position and is exposed by movement of the tool release sleeve rearwardly into its release position and wherein the locking body blocks forward movement of the sleeve back into its locked position if the tool is inserted in an incorrect orientation. Again, the exposure of the warning ring and the fact that the sleeve does not move into its release position when released alert the user to the fact that the tool is not locked within the tool holder. The user can then re-insert the tool in the correct orientation in which the locking body can move radially inwardly into the groove in the tool to allow the sleeve to move forwardly from its release position back into its locked position and cover the warning surface.

The tool holder according to the embodiments of the present invention may additionally include a biasing member for biasing the locking body forwardly within the slot. The biasing force provided by the biasing member helps to guide the locking body between its radially outward and inward positions. Where the tool release sleeve is manually axially slideable to axially move the locking member between its locked and release positions the biasing member can also be used to bias the locking member forwardly and thereby to biases the tool release sleeve forwardly.

In a further embodiment the warning surface is located on the biasing member and the trapping of the locking body in its radially outward position traps the biasing member in a position in which the warning surface is exposed and made clearly visible to a user of the tool holder. In one version of this second preferred embodiment the tool can be locked in the tool holder without the manual actuation of the tool release sleeve and the slot in the tool holder body extends rearwardly of the locking member by a sufficient distance to enable the rearward end of an inserted tool to push the locking body rearwardly into its radially outward position against the biasing force of the biasing member and thereby to move the biasing member into a rearward position wherein the brightly coloured warning surface is located on a portion of the biasing member which portion is exposed when the biasing member is in its rearward position. If the tool is inserted in an incorrect orientation, the locking body cannot move radially inwardly and forwardly under the biasing force of the biasing member and is trapped in the radially outward position by a flat of the shank of the hex-shanked tool. This means that the biasing member cannot move forwardly and so the brightly coloured warning surface remains exposed to alert the user to the fact that the tool is not locked within the tool holder. The user can then remove the tool and re-insert it in the tool holder in the correct orientation. The locking body can then move radially inwardly and forwardly to engage the groove under the biasing force of the biasing member, which itself moves forwardly which hides the warning surface from view. Preferably, the biasing member includes a rearwardly extending collar, the radially outward facing surface of which is the brightly coloured warning surface. In a forward position of the biasing member the portion of the biasing member may be covered by the tool release sleeve and in a rearward position of the biasing member the portion of the biasing member may extend beyond the rearward edge of the tool release sleeve and is thereby exposed.

The locking member may be a locking ring which fits non-rotatably around the forward end of the tool holder body and the tool release sleeve may be non-rotatably mounted on the locking ring to thereby non-rotatably fix the tool release sleeve onto the tool holder body. The use of a locking ring provides a robust locking member for absorbing impacts transmitted from the locking body during use of the hammer when the locking ring locks the locking body in the groove in the hex-shanked tool.

In one embodiment which is ergonomic and allows a relatively simple and robust tool holder design, the tool release sleeve is manually axially slideable to axially move the locking member between its locked and release positions.

To improve guidance of the locking body between its radially inward and radially outward positions the radially outermost surface of the locking body may engage the radially innermost surface of the locking member in the locked position and a sloping surface on the locking body which extends radially inwardly of the radially outermost surface of the locking body may engage a sloping surface of the locking member which extends radially outwardly of the radially innermost surface of the locking member in the release position or positions. The use of the sloping surfaces prevents the locking body becoming jammed in its movement between its radially inward and radially outward position. Where the tool release sleeve is manually axially slideable to axially move the locking member between its locked and release positions the sloping surfaces are forward and/or rearward facing.

The forward movement of the locking body within the slot may be limited by a damping arrangement which arrangement is axially fixed against forward movement on the forward portion of the tool holder body. When the hammer moves from operating mode to idle mode there is a high forward impact on the locking body from the last forward impact from the tool and the damping arrangement damps this impact as it transmits this impact from the locking body to the tool holder body. This means that the maximum impact force received by the tool holder body is reduced.

According to a second aspect of the present invention there is provided an electrically powered hammer, which may have a pneumatic striking mechanism comprising a piston and ram located so as to reciprocate within a hollow spindle, additionally including a tool holder as described above. The tool holder may be located forward of and co-axially with the hollow spindle.

### BRIEF DESCRIPTION OF THE DRAWINGS

One form of rotary hammer incorporating a tool holder according to the present invention will now be described by way of example with reference to the accompanying drawings in which:

FIG. 1 shows a partially cutaway longitudinal cross section through a demolition hammer incorporating a tool holder according to the present invention;

FIG. 2A shows a longitudinal cross-section of the tool holder of the demolition hammer shown in FIG. 1;

FIG. 2B shows a view similar to that shown in FIG. 2A but with a hex-shanked tool inserted in an incorrect orientation within the tool holder;

FIG. 3A shows a first perspective view of the shank of a hex-shanked tool or bit with the axially extending groove uppermost;

FIG. 3B shows a second perspective view of the shank of a hex-shanked tool or bit with the axially extending groove facing sideways;

FIG. 3C shows a third perspective view of the shank of a hex-shanked tool or bit with the axially extending groove uppermost with the remote faces of the shank indicated by dotted lines;

FIG. 3D shows a view of the end of the shank of a hex-shanked tool or bit which end is inserted into the tool holder portion of a hammer;

FIG. 4A shows a longitudinal cross-section of an alternative tool holder to that shown in FIGS. 1 to 2B with a hex-shanked tool or bit inserted in the correct orientation; and

FIG. 4B shows a view similar to that shown in FIG. 4A but with a hex-shanked tool inserted in an incorrect orientation within the tool holder.

### DETAILED DESCRIPTION OF THE INVENTION

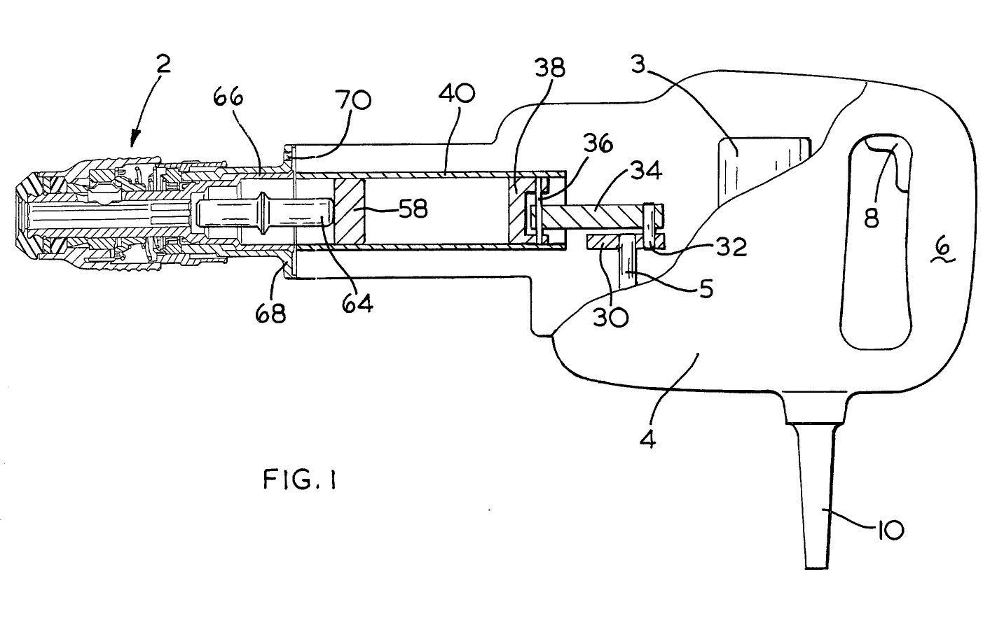

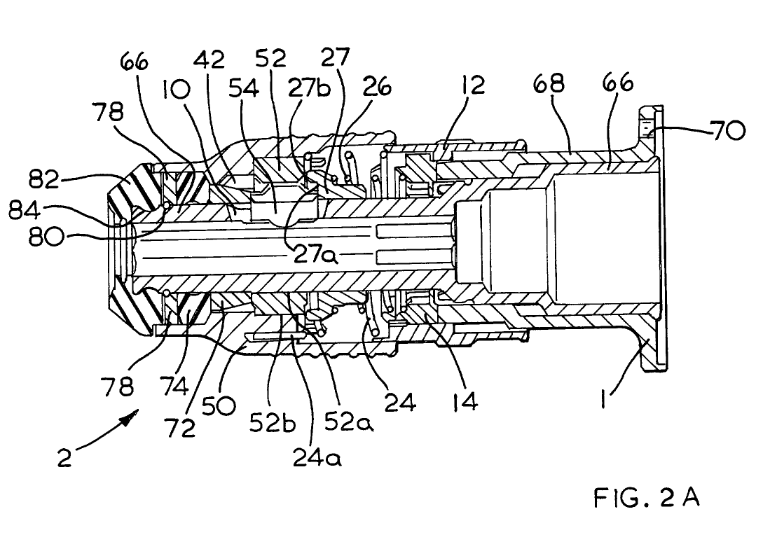

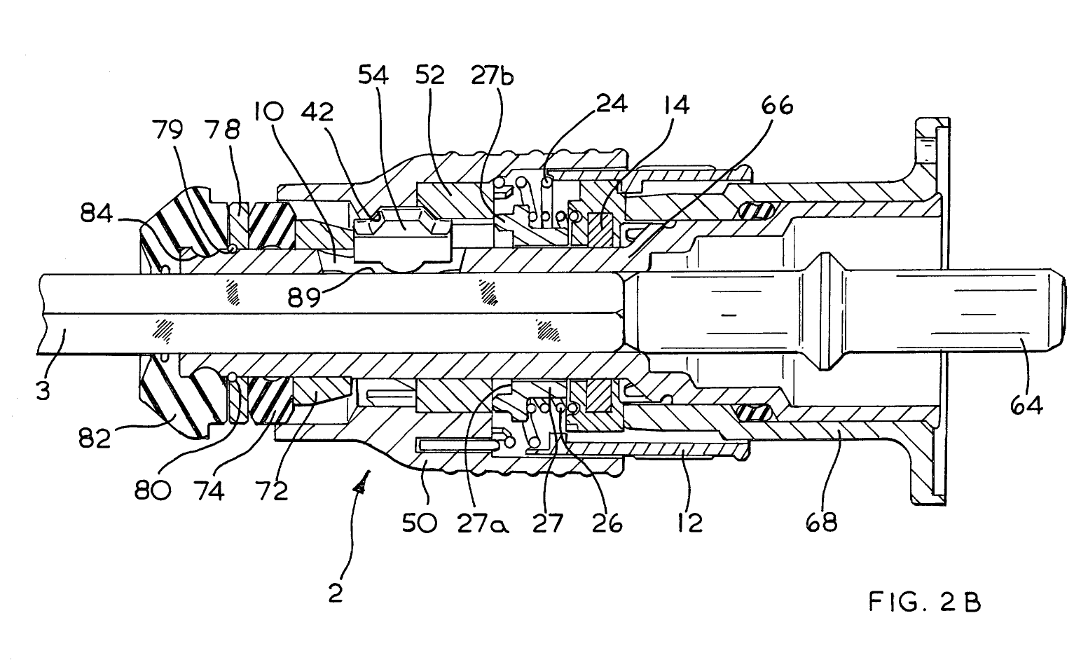

A demolition hammer incorporating a tool holder (2) according to the present invention is shown in FIGS. 1 and 2. The hammer comprises an electric motor (3), a gear arrangement and a piston drive arrangement which are housed within a metal gear housing (not shown) surrounded by a plastic housing (4). A rear handle housing incorporating a rear handle (6) and a trigger switch arrangement (8) is fitted to the rear of the housings (4). A cable (not shown) extends through a cable guide (10) and connects the motor to an external electricity supply. Thus, when the cable is connected to the electricity supply and the trigger switch arrangement (8) is depressed the motor (3) is actuated to rotationally drive the armature of the motor.

The motor pinion rotatingly drives a first gear wheel of an intermediate gear arrangement which is rotatably mounted on a spindle, which spindle is mounted in an insert to the gear housing. The intermediate gear has a second gear wheel which rotatingly drives a drive gear. The drive gear is non-rotatably mounted on a drive spindle (5) which spindle is rotatably mounted within the gear housing. A crank plate (30) is non-rotatably mounted at the end of the drive spindle (5) remote from the drive gear, which crank-plate is formed with an eccentric bore for housing an eccentric crank pin (32). The crank pin (32) extends from the crank plate into a bore at the rearward end of a crank arm (34) so that the crank arm (34) can pivot about the crank pin (32). The opposite forward end of the crank arm (34) is formed with a bore through which extends a trunnion pin (36) so that the crank arm (34) can pivot about the trunnion pin (36). The trunnion pin (36) is fitted to the rear of a solid piston (38) by fitting the ends of the trunnion pin (36) into receiving bores formed in a pair of opposing arms which extend to the rear of the piston (38). The piston is mounted in a cylindrical hollow spindle (40) so that it can reciprocate within the hollow spindle. An O-ring seal is fitted in an annular recess formed in the periphery of the piston (38) so as to form an air tight seal between the piston (38) and the internal surface of the hollow spindle (40).

Thus, when the motor (2) is actuated, the armature pinion rotatingly drives the drive spindle (5) via the gear arrangement. The drive spindle rotatingly drives the crank plate (30) and the crank arm arrangement comprising the crank pin (32), the crank arm (34) and the trunnion pin (36) convert the rotational drive from the crank plate (30) to a reciprocating drive to the piston (38). In this way the piston (38) is reciprocatingly driven back and forth along the hollow spindle (40) when the motor is actuated by a user depressing the trigger switch (8).

A ram (58) is located within the hollow spindle (40) forwardly of the piston (38) so that it can also reciprocate within the hollow spindle (40). An O-ring seal is located in a recess formed around the periphery of the ram (58) so as to form an air tight seal between the ram (58) and the spindle (40). In the operating position of the ram (58) a closed air cushion is formed between the forward face of the piston (38) and the rearward face of the ram (58). Thus, reciprocation of the piston (38) reciprocatingly drives the ram (58) via the closed air cushion. When the hammer enters idle mode the air cushion is vented and so the ram (58) is no longer reciprocatingly driven by the piston (38) in idle mode, as is well known in the art.

A beatpiece (64) is guided so that it can reciprocate within a tool holder body (66) which tool holder body is mounted at the forward end of the hammer housing co-axially with the spindle. The tool holder body is mounted within a flange (68) which is fitted to the main housing of the hammer by a plurality of bolts (not shown) which extend axially through receiving bores (70) in a collar located at the rearward end of the flange (68). The bolts extend into co-operating receiving screw threaded bores formed in the forward part of the main housing of the hammer. A hex-shanked bit or tool (3) can be releasably mounted within the tool holder body (66) so that the tool can reciprocate to a limited extent within the tool holder body (66). When the ram (58) is in its operating mode and is reciprocatingly driven by the piston (38) the ram repeatedly impacts the rearward end of the beatpiece (64) and the beatpiece (64) transmits these impacts to the rearward end of the tool or bit (3) as is known in the art. The impacts are then transmitted by the tool (3) to the material being worked.

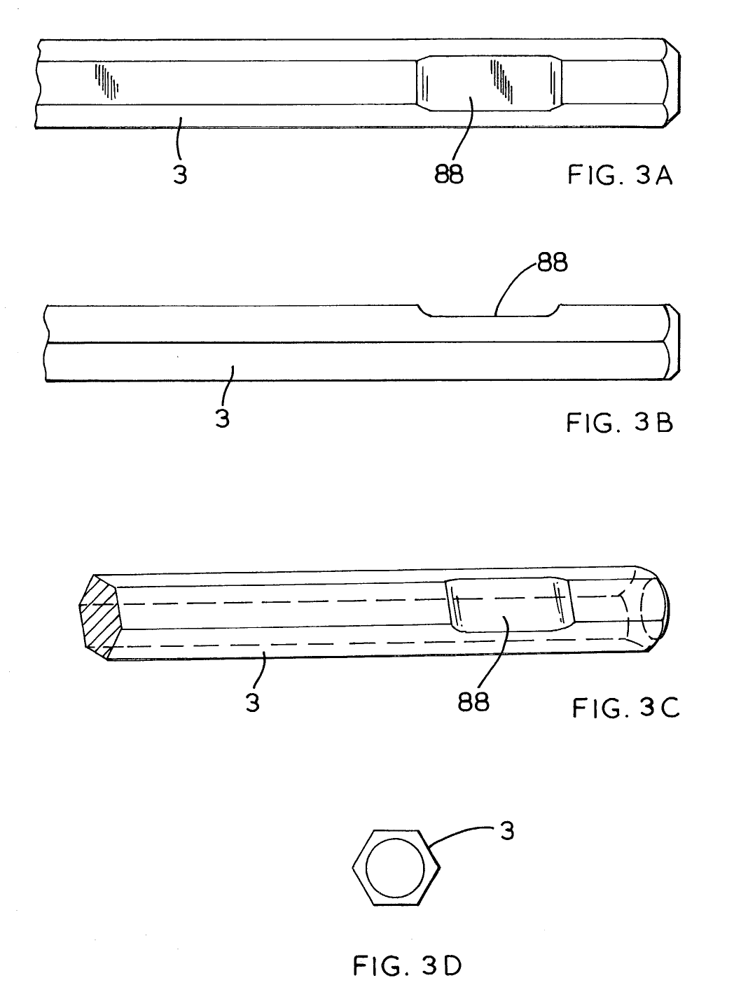

The tool holder (2) of the hammer of FIG. 1 is shown in more detail in FIGS. 2A and 2B. The tool holder (2) comprises a tube-like tool holder body (66). The tool holder body had a relatively large internal diameter cylindrical portion at its rearward end for housing the beatpiece (64) and a relatively small diameter hexagonally cross-sectioned portion at its forward end for receiving the shank of a hex-shanked tool (3) of the type shown in FIGS. 3A to 3D.

A single axially extending slot (10) is formed in the hexagonally cross-sectioned portion of the tool holder body (66) through which a single locking body (54) extends. The locking body (54) is prevented from radially outward movement by a locking ring (52) which extends around the hexagonally cross-sectioned portion of the tool holder body (66). The locking ring (52) has a radially inward facing face which has a generally hexagonal transverse cross-section, except for a recess in said face for accommodating the locking body (54). Due to the hexagonal transverse cross-section of the radially outwardly facing surface of the hexagonally cross-sectioned portion of the tool holder body (66), the locking ring is non-rotatable on said portion of the tool holder body. The locking ring (52) has an irregularly shaped radially outwardly facing surface which is non-rotatably received within a co-operating recess of a tool release sleeve (50). The recess in the tool release sleeve (50) is formed by a rearwardly facing internal shoulder formed in the tool release sleeve. In this manner the tool release sleeve (50) is non-rotatably mounted on the tool holder body via the locking ring (52).

The locking body (54) and locking ring (52) are urged axially forwardly by a biasing sleeve (27) which has a recessed forward facing face (27a) with a raised rim (27b). The recessed forward face (27a) bears on the rearward end of the locking body (54) and the raised rim (27b) bears on the locking ring (52). The biasing sleeve (27) is urged forwardly by a first small diameter compression spring (26). A second larger diameter compression spring (24) bears against the tool release sleeve (50) to urge it axially forwardly. The tool holder release sleeve (50) is also forwardly biased by the biasing sleeve (27) via the locking ring (52). The forward end (24a) of the compression spring (24) is mounted within an axially extending recess formed in the tool release sleeve (50). The springs (24, 26) are mounted at their rearward ends on parts of an arrangement for adjusting the orientation of the tool holder body (66) within the flange (68), which arrangement comprises an actuation sleeve (12) and a lock ring (4) and is not described further here.

The forward movement of the locking body (54) is limited by a damping mechanism for damping the forward impact to the locking body (54) when the hammer enters idle mode. The damping arrangement comprises a metal ring (72) located in front of the locking body (54) and the locking ring (52) which is non-rotatably mounted over the hexagonal portion of the tool holder body (66). In front of the metal ring (72) is located a resilient ring (74) which is also mounted over the hexagonal portion of the tool holder body (66). The rings (72, 74) are held in place against axially forward movement by a washer (78) which is non-rotatably fitted over the hexagonal portion of the tool holder body (66) and held in place by a snap ring which is fitted into an annular recess (80) formed in the radially outwardly facing surface of hexagonal portion of the tool holder body (66). A resilient rubber nose ring (82) is snap fitted over the forward portion of the hexagonal portion of the tool holder body (66) so that part of the nose ring (82) is retained in an annular recess (84) formed in the radially outwardly facing surface of the hexagonal portion of the tool holder body (66). The locking ring (52) is held against axially forward movement by the damping mechanism (72, 74, 78) and by the tool release sleeve (50) which is itself prevented against axially forward movement by the resilient ring (74) of the damping mechanism and by the nose ring (82). The washer (78) has a radially outward facing surface which is coloured a bright warning colour, such as bright red.

The axially extending slot (10) formed in the hexagonal portion of the tool holder body (66) extends only a small distance rearwardly of the rearward end of the locking body (54). This means that the locking body cannot be pushed rearwardly of the locking ring (52) when a tool (3) is inserted into the tool holder body (66) and so cannot be moved radially outwardly automatically by the insertion of a tool. Instead to insert a hex-shanked tool the locking sleeve (50) must be moved axially rearwardly against the force of the springs (24,26). When the sleeve (50) is moved axially rearwardly the coloured outer facing surface of the washer (78) is exposed, as shown in FIG. 2B. When the sleeve (50) is moved rearwardly, a pocket (42) formed within the sleeve (50) is moved radially outwardly of the locking body (54), thus enabling the locking body (54) to move radially outwardly to allow a hex shanked tool to be fitted into the tool holder body (66). If the hex-shanked tool is inserted into the tool holder in the correct orientation, then once the locking groove (88) in the hex-shanked tool (3) is aligned with the locking body (54), the sleeve (50) can be released and moves forwardly into its locked position by the action of the springs (24,26). As the sleeve moves forwardly (to the left in FIG. 2B) into its locked position the locking body (54) is pushed radially inwardly into its locked position by the locking ring (52) due to the engagement of the sloped edges of the locking ring (52) and locking body (54). In the locked position the locking body (54) and the tool release sleeve (50) are in the position shown in FIG. 2A. The locking body (54) is maintained in the locking groove (88) of the hex shanked tool by the locking ring (52).

If the hex-shanked tool is inserted in the incorrect orientation, when the sleeve (50) is moved rearwardly a pocket (42) formed within the sleeve (50) is moved radially outwardly of the locking body (54), thus enabling the locking body (54) to move radially outwardly to allow the hex shanked tool to be fitted into the tool holder body (66), as before. When the sleeve (50) is moved axially rearwardly the coloured outer facing surface of the washer (78) is exposed, as shown in FIG. 2B. However, a flat surface (89) of the shanked of the hex-shanked tool will be facing the locking body (54). Thus, the locking body (54) is unable to move radially inwardly from its location in the pocket (42) formed within the sleeve (50). The locking body (54) is trapped in the pocket (42) and prevents forward motion of the tool release sleeve (50) and so when the tool release sleeve (50) is released by a user, it remains in its rearward position, as shown in FIG. 2B. The tool release sleeve (50) will not move forwardly into its unlocked position unless the orientation of the tool is correct. This is because if the hex-shanked tool is not correctly oriented there is no locking groove (88) radially inwardly of the locking body (54) for the locking body (54) to move into. In an incorrect orientation a flat side (89) of the hex shaft tool prevents the locking body (54) from moving radially inwardly from its locked position and so the locking body is locked in the pocket (42) in the sleeve (50) by a flat side (89) of the tool. This means that the locking body (54) blocks the forward movement of the locking sleeve (50). The user will notice that the tool release sleeve (50) has not moved forwardly into its locked position, firstly because the user will notice that the sleeve (50) has not moved forwardly on release and secondly because the coloured outer face of the washer (78) is exposed as a warning to the user that the tool is not locked in the tool holder body (66).

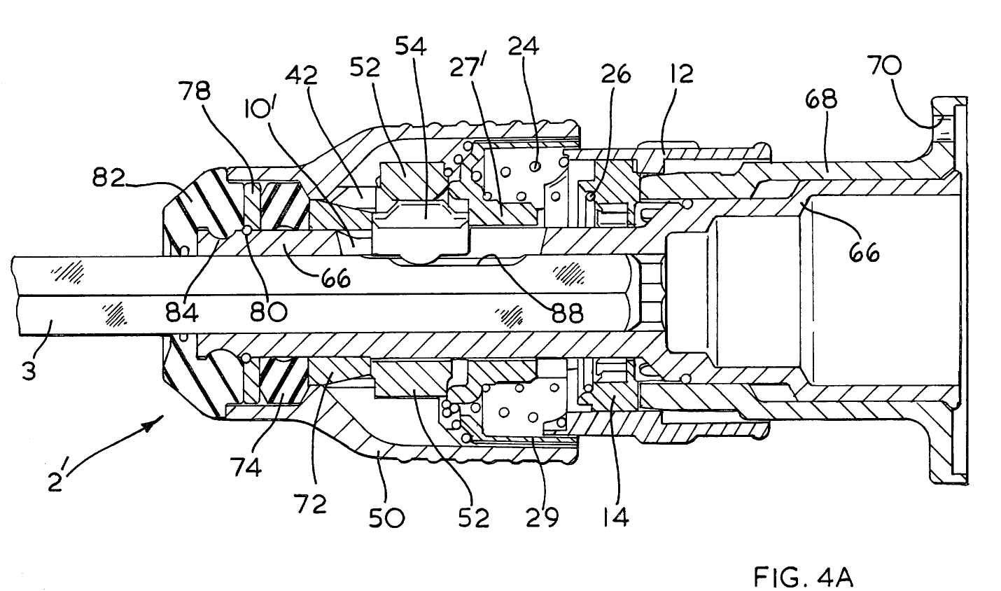

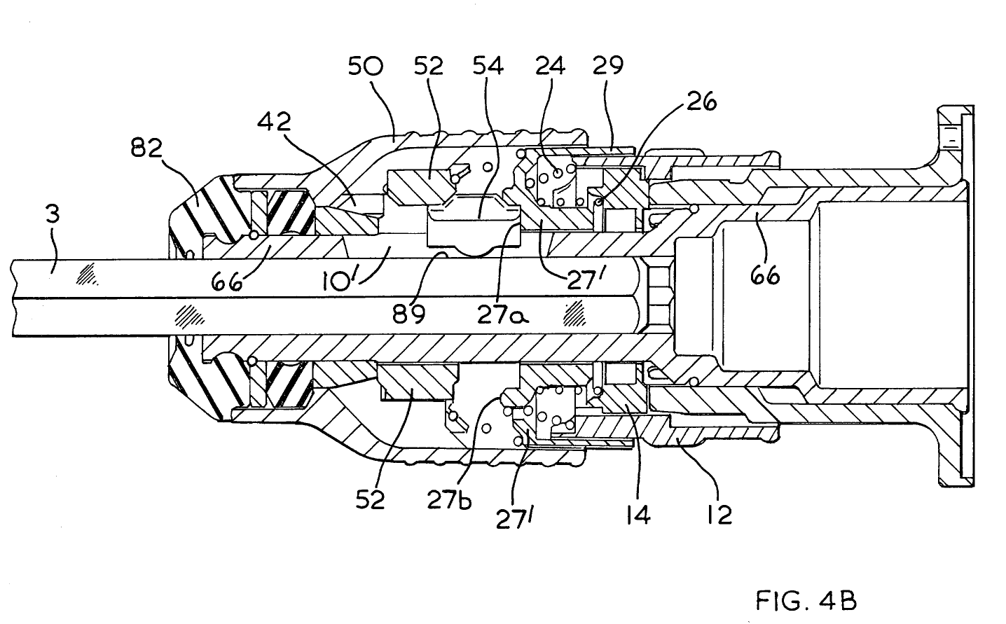

An alternative design of tool holder (2′) to that shown in FIGS. 2A and 2B is shown in FIGS. 4A and 4B, with like parts identified by like numerals. The design of tool holder shown in FIGS. 4A and 4B allows automatic locking of a hex-shanked tool within the tool holder without manual actuation of the tool release sleeve (50).

In the arrangement in FIGS. 4A and 4B the axially extending slot (10′) in the hexagonally cross-sectioned portion of the tool holder body (66) extends for some distance rearwardly of the rest position (shown in FIG. 4A) of the locking body (54). The biasing sleeve (27′) again has a recessed forward face (27a) which bears forwardly against the rearward end of the locking body (54) and a forwardly projecting rim (27b) which bears forwardly on the locking ring (52) and thereby forwardly biases the tool release sleeve (50). The biasing sleeve (27′) is forwardly biased by a compression springs (24,26) which at their rearward end bear against parts of a mechanism (12, 4) for altering the orientation of the tool holder body (66). However, in the design shown in FIGS. 4A and 4B the biasing sleeve also has a rearwardly extending outer cylindrical collar (29), the rearward portion of which is mounted slideably between the radially outward facing face of the forward portion of the sleeve (12) and the radially inward facing face of the rearward portion of the tool release sleeve (50). The radially outwardly facing face of the rearward portion of the cylindrical collar (29) is coloured a bright warning colour, such as red.

Thus, on insertion of a hex-shanked tool into the tool holder body (66) the rearward end of the tool engages the locking body (54) to push the locking body (54) rearwardly along the axially extending slot (10′) against the biasing force of the biasing sleeve (27′). The locking body (54) is moved rearwardly past the locking ring (52) and so can move radially outwardly into the position shown in FIG. 4B. The forward sloping face of the locking body (54) engages the rearward sloping face of the locking ring (52) as the locking body (54) is pushed radially outwardly, out of the path of the shank of the hex-shanked tool, by the hex-shanked tool. This is an unlocked position of the locking body (54). In this unlocked position, the locking body (54) maintains the biasing sleeve (27′) in a rearward position as shown in FIG. 4B, in which the rearward portion of the collar (29) of the biasing sleeve (27′) extends beyond the rearward end of the tool release sleeve (50). Thus, the brightly coloured portion of the collar (29) is exposed to warn a user that the locking body (54) is not in its locked position.

If the hex-shanked tool is inserted in the correct orientation then after the locking body (54) is moved radially outwardly, the shank (3) can be moved further into the tool holder body (66) until the groove (88) in the shank is radially inwardly of the locking body (54). Then the biasing sleeve (27′) urges the locking body (54) forwardly and by co-operation of the sloping surfaces at the rear of the locking ring (52) and the forward end of the locking body (54) the locking body is urged radially inwardly into the groove (88) in the shank of the hex shanked tool (3), that is into the position shown in FIG. 4A. As the biasing sleeve (27′) is now moved axially forwardly, the brightly coloured portion of the collar (29) is no longer exposed and the user knows that the locking body (54) is in its locked position and the tool (3) is securely locked within the tool holder body (66).

If the shank of the hex-shanked tool is inserted into the tool holder body (66) in the incorrect orientation, ie. with the groove (88) of the hex shank not facing the locking body, then as before after the locking body (54) is moved radially outwardly, the shank can be moved further into the tool holder body (66) to the position shown in FIG. 4B. As there is no groove (88) in the shank (3) radially inwardly of the locking body (54) the locking body cannot move radially inwardly and is trapped behind the locking ring (52) in the position shown in FIG. 4B. In this position the biasing sleeve (27′) is in its rearward position and the brightly coloured portion of the collar (29) of the biasing sleeve (27′) is exposed. Thus, a user of the tool is alerted to the fact that the tool (3) is not locked within the tool holder body (66). The user can then remove the tool (3) from the tool holder body (66) and reinsert it in the correct orientation, as described above. In the correct orientation, when the tool is locked in the tool holder body (66), the brightly coloured collar portion (29) of the biasing sleeve (27′) will be hidden under the tool release sleeve (50), as shown in FIG. 4A.

In the tool holder shown in FIGS. 4A and 4B, as with the tool holder in FIGS. 2A and 2B, to remove a locked tool from the tool holder, the tool release sleeve (50) is moved axially rearwardly to align the pocket (42) in the tool release sleeve (50) radially outwardly of the locking body (54). Then the tool (3) can be pulled from the tool holder body (66) and the locking body (54) moves radially outwardly into the pocket (42) and out of the groove (88) in the tool (3). Once the tool (3) is removed the tool release sleeve (50) is released and urged forwardly by the springs (24, 26) and biasing sleeve (27,27′) into its forward position.

1. A tool holder, in a powered hammer, for non-rotatably receiving a tool shank having an axially extending closed groove, said tool holder comprising:
a tool holder body located at the front of the hammer and defining an axial bore and a radial slot;
a locking body located in said slot and moveable between a radially inward position and a radially outward position and when in the radially inward position said locking body is engageable with the axially extending closed groove of the tool shank;
a locking member movable between a locked position and a release position and when in the locked position said locking member locks the locking body in the radially inward position and when in the release position said locking member allows the locking body to move into the radially outward position to allow a tool shank to be inserted into or removed from the bore of the tool holder body;
a tool holder release sleeve operatively connected to the locking member for moving the locking member between the locked position and the release position position;
a warning surface, which warning surface is covered when the locking body engages the groove in the tool shank and;
wherein the tool holder is arranged so that when a tool shank is fitted into the tool holder body in an incorrect orientation, then the tool shank traps the locking body in the radially outward position and the warning surface is visible to a user of the tool holder.

2. A tool holder according to claim 1 wherein the warning surface is covered by the tool holder release sleeve when the locking body engages the closed groove in the tool shank.

3. A tool holder according to claim 1 wherein, when the locking body is trapped in the radially outward position, said locking body holds the tool holder release sleeve in a position in which the tool holder release sleeve does not cover the warning surface, so that the warning surface is visible to a user of the tool holder.

4. A tool holder according to claim 1 wherein the tool holder release sleeve is moveable between a locked position and a release position, and wherein the warning surface is covered by the tool holder release sleeve when the tool holder release sleeve is in the locked position, and the warning surface is visible when the tool holder release sleeve is in the release position, and wherein the locking body blocks movement of the tool holder release sleeve into the locked position, if the tool shank is inserted in an incorrect orientation.

5. A tool holder according to claim 1 wherein the tool holder release sleeve includes a forward portion and is axially slideable between a forward locked position and a rearward release position, and wherein the warning surface is covered by the forward portion of the tool holder release sleeve when the tool holder release sleeve is in the forward position, and the warning surface is visible when the tool holder release sleeve is in the rearward position, and wherein the locking body blocks forward movement of the tool holder release sleeve into the locked position, if the tool shank is inserted in an incorrect orientation.

6. A tool holder according to claim 1 additionally including a biasing member for biasing the locking body forwardly within the slot.

7. A tool holder according to claim 1 additionally including a biasing member for biasing the locking body forwardly within the slot to thereby bias the tool release sleeve forwardly.

8. A tool holder according to claim 1 additionally including a biasing member for biasing the locking body forwardly within the slot, wherein the warning surface is located on the biasing member and the trapping of the locking body in the radially outward position traps the biasing member in a position in which the warning surface is visible to a user of the tool holder.

9. A tool holder according to claim 1 additionally including a biasing member movable between a forward position and a rearward position, and when in the forward position said biasing member forces the locking body forwardly within the slot, and when the tool shank is inserted into the tool holder body, the tool shank forces the locking body axially rearwardly and into the radially outward position against the biasing member and the locking body thus moves the biasing member into the rearward position, and the warning surface is located on the biasing member and is visible to a user of the tool holder when the biasing member is in the rearward position.

10. A tool holder according to claim 9 wherein the biasing member includes a rearwardly extending collar having a radially outward facing surface, and the warning surface is located on said radially outward facing surface.

11. A tool holder according to claim 10, wherein in the forward position of the biasing member the warning surface is covered by the tool release sleeve and in the rearward position of the biasing member the warning surface extends beyond the tool release sleeve and is visible to a user of the tool holder.

12. A tool holder according to claim 1 wherein the locking member is non-rotatably mounted around the forward end of the tool holder body.

13. A tool holder according to claim 1 wherein the tool release sleeve is manually axially slideable to axially move the locking member between the locked position and the release position.

14. A tool holder according to claim 1 wherein the locking body includes a radially outermost surface and a first sloping surface, and the locking member includes a radially innermost surface and a second sloping surface, and when in the locked position said radially outermost surface of the locking body engages said radially innermost surface of the locking member, and when in the release position said first sloping surface on the locking body engages said second sloping surface of the locking member.

15. A tool holder according to claim 14 wherein the first sloping surface of the locking body is one of forward and rearward facing and the second sloping surface of the locking member is one of forward and rearward facing.

16. A tool holder according to claim 1, further including a damping element fixed to the tool holder body for limiting forward movement of the locking body within the slot.

17. A tool holder according to claim 1 wherein the tool holder body includes a forward end of reduced diameter.

18. A tool holder according to claim 1 wherein the bore of the tool holder body includes a radially inward facing surface, said inward facing surface having a hexagonal transverse cross-section.

19. An electrically powered hammer with a tool holder for releasably holding a tool shank with an axially extending closed groove, which tool holder comprises:
a tool holder body located at the front of the hammer and defining an axial bore and a radial slot;
a locking body located in said slot and moveable between a radially inward position and a radially outward position and when in the radially inward position said locking body is engageable with the axially extending closed groove of the tool shank;
a locking member movable between a locked position and a release position and when in the locked position said locking member locks the locking body in the radially inward position and when in the release position said locking member allows the locking body to move into the radially outward position to allow a tool shank to be inserted into or removed from the bore of the tool holder body;
a tool holder release sleeve operatively connected to the locking member for moving the locking member between the locked position and the release position;
a warning surface, which warning surface is covered when the locking body engages the groove in the tool shank and;
wherein the tool holder is arranged so that when a tool shank is fitted into the tool holder body in an incorrect orientation, then the tool shank traps the locking body in the radially outward position and the warning surface is visible to a user of the tool holder.

20. A hammer according to claim 19, further comprising a pneumatic striking mechanism including a hollow spindle, and a piston and a ram arranged for reciprocating movement within the hollow spindle.

21. A hammer according to claim 19, further comprising a pneumatic striking mechanism including a hollow spindle, and a piston and a ram arranged for reciprocating movement within the hollow spindle, and wherein the tool holder is located forward of and co-axially with the hollow spindle.

22. A hammer according to claim 19 wherein the warning surface is covered by the tool holder release sleeve when the locking body engages the closed groove in the tool shank.

23. A hammer according to claim 19 wherein, when the locking body engages the closed groove in the tool shank, then the warning surface is covered by the tool holder release sleeve, and wherein, when the locking body is trapped in the radially outward position, then the locking body traps the tool holder release sleeve in a position where said tool holder release sleeve does not cover the warning surface, so that the warning surface is visible to a user of the tool holder.

24. A hammer according to claim 19, wherein the tool holder release sleeve is moveable between a locked position and a release position, and wherein the warning surface is covered by the tool holder release sleeve when the tool holder release sleeve is in the locked position, and the warning surface is visible when the tool holder release sleeve is in the release position, and wherein the locking body blocks movement of the tool holder release sleeve into the locked position, if the tool shank is inserted in an incorrect orientation.

25. A hammer according to claim 19 wherein the tool holder release sleeve includes a forward portion and is axially slideable between a forward locked position and a rearward release position, and wherein the warning surface is covered by the forward portion of the tool holder release sleeve when the tool holder release sleeve is in the forward position, and the warning surface is visible when the tool holder release sleeve is in the rearward position, and wherein the locking body blocks forward movement of the tool holder release sleeve into the locked position, if the tool shank is inserted in an incorrect orientation.

26. A hammer according to claim 19 additionally including a biasing member for biasing the locking body forwardly within the slot.

27. A hammer according to claim 19 additionally including a biasing member for biasing the locking body forwardly within the slot to thereby bias the tool release sleeve forwardly.

28. A hammer according to claim 19 additionally including a biasing member for biasing the locking body forwardly within the slot, wherein the warning surface is located on the biasing member and the trapping of the locking body in the radially outward position traps the biasing member in a position in which the warning surface is visible to a user of the tool holder.

29. A hammer according to claim 19 additionally including a biasing member movable between a forward position and a rearward position, and when in the forward position said biasing member forces the locking body forwardly within the slot, and when the tool shank is inserted into the tool holder body, the tool shank forces the locking body axially rearwardly and into the radially outward position against the biasing member and the locking body thus moves the biasing member into the rearward position, and wherein the warning surface is located on the biasing member and is visible to a user of the tool holder when the biasing member is in the rearward position.

30. A hammer according to claim 29 wherein the biasing member includes a rearwardly extending collar having a radially outward facing surface, and the warning surface is located on said radially outward facing surface.

31. A hammer according to claim 30, wherein in the forward position of the biasing member the warning surface is covered by the tool release sleeve and in the rearward position of the biasing member the warning surface extends beyond the tool release sleeve and is visible to a user of the tool holder.

32. A hammer according to claim 19 wherein the locking member is non-rotatably mounted around the tool holder body.

33. A hammer according to claim 19 wherein the tool release sleeve is manually axially slideable to axially move the locking member between the locked position and the release position.

34. A hammer according to claim 19 wherein the locking body includes a radially outermost surface and a first sloping surface, and the locking member includes a radially innermost surface and a second sloping surface, and when in the locked position said radially outermost surface of the locking body engages said radially innermost surface of the locking member, and when in the release position said first sloping surface of the locking body engages said second sloping surface of the locking member.

35. A hammer according to claim 34 wherein the first sloping surface of the locking body is one of forward and rearward facing and the second sloping surface of the locking member is one of forward and rearward facing.

36. A hammer according to claim 19 further including a damping element fixed to the tool holder body for limiting forward movement of the locking body within the slot.

37. A hammer according to claim 19 wherein the tool holder body includes a forward end of reduced diameter.

38. A hammer according to claim 19 wherein the bore of the tool holder body includes a radially inward facing surface, said inward facing surface having a hexagonal transverse cross-section.
